(19) United States
(12) Patent Application Publication
(10) Pub. No.: US 2022/0192913 A1
(43) Pub. Date: Jun. 23, 2022

(54) SYSTEM, DEVICE AND METHOD FOR PROVIDING COMPRESSION THERAPY IN SYNCHRONIZATION WITH BREATHING CYCLE

(71) Applicant: Mego Afek AC Ltd., Kibbutz Afek (IL)

(72) Inventors: Asher BEN-NOON, Kibbutz Afek (IL); Gilad KENT, Kibbutz Ramat-David (IL)

(21) Appl. No.: 17/552,530

(22) Filed: Dec. 16, 2021

Related U.S. Application Data
(60) Provisional application No. 63/128,109, filed on Dec. 20, 2020.

(51) Int. Cl. A61H 9/00

(52) U.S. Cl. CPC A61H 9/0078; A61H 2201/165; A61H 2201/1619; A61H 2230/405; A61H 2201/5056; A61H 2205/084; A61H 2201/5071

(57) ABSTRACT

Provided herein is an inflatable compression vest for performing compression therapy to a subject afflicted with a respiratory related condition, wherein the vest includes at least one column of inflatable bladders, linearly arranged whereby for each three consecutive bladders, a top bladder and a bottom bladder at least partially overlaps with a middle intervening bladder. Further provided are controller device configured to control operation of the compression vest in accordance with the breathing cycle of a subject, systems and methods of using the same.

### CROSS REFERENCE TO RELATED APPLICATIONS

This application claims the benefit of priority of U.S. Provisional Application No. 63/128,109 filed Dec. 20, 2020, the contents of which are all incorporated herein by reference in their entirety.

### FIELD OF THE INVENTION

The invention, in some embodiments thereof, relates to system, device and method for providing compression therapy utilizing compression vest operative in synchronization with breathing cycle.

### BACKGROUND

Compression therapy is used to apply controlled pressure to body parts, for example, to improve blood flow, prevent or reduce blood clots formation, and the like. Compression therapy may be applied, for example, by a bandage fitted on or around the body part (such as a limb) subjected to the compression therapy. Other type of compression therapy utilizes pneumatic compression therapy. This form of treatment is performed using a compression device, which feeds compressed air to a garment or sleeve containing one or more cells which inflate and deflate, alternately applying and releasing pressure to the extremities of the patient.

Respiratory related condition may arise from various causes, including infections, inflammation, mutations and may be acute or chronic. In many cases, respiratory related conditions can be life threatening and in other cases, such conditions are at least partially debilitating. Treatments of respiratory related conditions include various medication, subject ventilation and in some cases, manual physiotherapy, to assist in breathing, increase air flow, release blocked airways, and the like.

U.S. Pat. No. 6,846,295 discloses a compression sleeve that is made of a first and a second sheet of a flexible material each having distal and proximal end edges and two lateral edges extending therebetween. The sheets are connected one to the other by a plurality of longitudinal connection lines transverse to the lateral edges, thus they form a plurality of longitudinal pressure cells each defined between a pair of connection lines and first and second strip regions of the respective first and second sheets. The width of the second strip region between said pair of connection lines is greater than the width of the first strip region. The pressure cells are inflatable and, when inflated to exert pressure on a body, the second strip region of one cell overlaps the second strip region of an immediately adjacent neighboring cell.

There remains a need in the art for inflatable compression garments capable of providing effective compression therapy useful to ameliorate various respiratory related conditions, wherein the compression therapy is provided in synchronization with the breathing cycle of a subject undergoing treatment.

### SUMMARY

Aspects of the invention, in some embodiments thereof, relate to systems, devices and methods for providing compression therapy to a subject suffering from a condition related to the breathing/ventilation/respiratory system. According to some embodiments, there are provided advantageous compression garments, for example, in the form of vests, capable of providing efficient pneumatic compression therapy to treat, alleviate or at least partially ameliorate respiratory related condition of a subject treated with the compression vest. In some embodiments, the compression vests include a plurality of advantageous inflatable bladders (chambers), at least partially overlapping at wall portions thereof, in order to allow an efficient, localized and customized compression therapy. According to some embodiments, further provided herein are controller devices for controlling the operation of the compression vest to allow synchronization/coordination with the breathing cycle of the subject, as well as systems utilizing the compression vest and controller device to provide an optimized and personalized compression therapy.

According to some embodiments, the compression garments (such as vests) disclosed herein are advantageous, as they allow providing a customized and localized compression therapy to a subject, wherein the provided therapy can at least partially mimic or replace manual compression/massaging therapy provided by a health care provider (such as a physician, nurse, physiotherapist, and the like). In some embodiments, the advantageous function of the compression vest is at least partially achieved by a plurality of at least partially overlapping inflatable bladders, arranged consecutively in columns, wherein in an arrangement of each three consecutive bladders, the two external bladders overlap the middle bladder.

In some exemplary embodiments, the garment is a vest including two columns, each column includes a set of three bladders each, wherein the top (first) bladder and the bottom (last) bladder at least partially overlap with the middle bladder, and wherein the two columns substantially parallel to each other, where one column is configured to be placed on a right region of the chest and the second columns is configured to be placed on a left region of the chest of the subject.

According to some embodiments, the advantageous vest disclosed herein is configured for use in pneumatic compression therapy, in particular for conditions related to the breathing/ventilation/respiration system of a subject. In some embodiments, the compression therapy is coordinated/synchronized/in accordance with stages of the breathing cycle of the subject (inhalation/exhalation stages), to increase efficiency and accuracy thereof.

According to some embodiments, there is provided an inflatable compression vest for providing compression therapy to a subject, the compression vest includes at least one column of inflatable bladders, the column includes at least three inflatable bladders consecutively (linearly) arranged in the column, wherein for each three consecutive bladders, a top (first) and a bottom (last) bladder at least partially overlap with an intervening middle bladder.

According to some embodiments, the vest may include at least two columns, each column having at least three consecutive inflatable bladders, wherein for each three consecutive bladders, a top and a bottom bladder at least partially overlap with an intervening middle bladder. According to some embodiments, the two columns are substantially parallel thereto and are configured to be placed on the chest of the subject.

According to some embodiments, the bladders are configured to inflate, deflate or maintain pressure therein.

According to some embodiments, each of the bladders may have a ventilation opening configured to allow inflating and/or deflating the bladder.

According to some embodiments, the inflation of the bladder may be performed by compressing fluid into the bladder via the ventilation opening.

According to some embodiments, the bladders are configured to inflate, deflate or maintain pressure, individually, concomitantly and/or sequentially.

According to some embodiments, one or more of the bladders may be configured to change or maintain pressure in accordance with stages of the breathing cycle of the subject.

According to some embodiments, each of the bladders is configured to change or maintain pressure in accordance with stages of the breathing cycle of the subject.

According to some embodiments, walls of the bladders are made of sheets of PE, EVA, PVC and/or TPU.

According to some embodiments, the overlapping bladders are manufactured using RF welding, adhesion, gluing and/or stitching of respective walls of the bladders.

According to some embodiments, the bladders in each column may be identical, similar, or different with respect of size, shape and/or composition.

According to some embodiments, the two columns may be identical, similar or different with respect of shape, size, number of bladders, distribution of bladders and/or bladder characteristics.

According to some embodiments, the vest may further include one or more fastening elements configured to fasten/secure the vest to the subject's body and/or to fasten removably detachable portions of the vest thereto.

According to some embodiments, the pressure within the bladders may be in the range of about 15-120 mmHg.

According to some embodiments, for vest may be for use in compression therapy of a respiratory related condition of a subject in need thereof.

According to some embodiments, the respiratory related condition is selected from: asthma, chronic obstructive pulmonary disease (COPD), chronic bronchitis, emphysema, acute bronchitis, cystic fibrosis (CF), pneumonia, tuberculosis, pulmonary edema, acute respiratory distress syndrome (ARDS), COVID-19 infection, pneumoconiosis, interstitial lung disease (ILD), pulmonary embolism (PE), pulmonary hypertension, pleural effusion, pneumothorax, mesothelioma and obesity hypoventilation syndrome.

According to some embodiments, there is provided a controller device for controlling operation of a compression vest in accordance/coordination with the breathing cycle of a subject, the device includes: a sensor unit configured to detect one or more parameters related to breathing of the subject; a processing unit configured to process data obtained from the sensor unit to at least partially determine stages of the breathing cycle of the subject and/or air pressure values during the breathing cycle; and a control unit configured to control pressure in the compression vest, based on data processed by the processing unit, wherein the pressure in the compression vest is determined in accordance with the determined breathing cycle stages and/or the air pressure values during the breathing cycle.

According to some embodiments, the sensor unit may include: a pressure sensor, a flow sensor, a movement (motion) sensor, a strain sensor, or combinations thereof. In some embodiments, the pressure sensor and/or the flow sensor are located along exhaled and/or inhaled air path of the subject. According to some embodiments, the motion sensor is located on the chest of the subject, and is configured to sense chest movement during breathing cycle and optionally.

According to some embodiments, the sensed air pressure values are in the range of about −20 to +30 mmHg.

According to some embodiments, the controller device may include one or more fluid compressors configured to inflate or deflate the compression vest, based on instructions from the control unit.

According to some embodiments, the controller device may further include one or more valves, configured to control pressure in bladders of the compression vest. According to some embodiments, the valves may be electrical solenoid valves.

According to some embodiments, the controller device may further include a user interface unit. According to some embodiments, the user interface unit may include one or more of: keyboard, display, tracking device, touch screen, or any combination thereof.

According to some embodiments, the controller device may further include a communication unit.

According to some embodiments, the communication unit may include wired and/or wireless communication modalities. In some embodiments, the communication unit may include Bluetooth communication modality, Wi-Fi communication modality, Near field communication modality (NFC), ethernet, USB, HDMI, or combinations thereof.

According to some embodiments, the controller device is configured to inflate, deflate or maintain pressure in the compression vest, based on the determined breathing cycle stages and/or the air pressure values during the breathing cycle of the subject.

According to some embodiments, the controller device is configured to operate continuously, or intermittently.

According to some embodiments, there is provided a system for providing compression therapy to a subject, in synchronization with the breathing cycle of the subject, the system includes the compression vest as disclosed herein and the controller device as disclosed herein.

According to some embodiments, there is provided a method for providing a compression therapy to a subject in need thereof, the method includes one or more of the steps of:
placing a compression vest as disclosed herein on the subject, wherein the at least one column of bladders is placed on the chest of the subject;
sensing one or more parameters related to breathing of the subject; and
controlling the pressure in the compression vest in accordance with stages of breathing cycle of the subject and/or air pressure values during the breathing cycle, said stages and/or air pressure values are determined based on the one or more sensed parameters.

According to some embodiments, the step of sensing and the step of controlling the pressure may be repeated continuously.

According to some embodiments, controlling the pressure in the compression vest may include reducing, maintaining, or increasing the pressure in one or more bladders of the compression vest.

According to some embodiments, the method may further include placing one or more sensors on or along the exhaled and/or inhaled airway pathway of the subject and/or on the subject body, wherein the sensors are configured to sense the one or more parameters related to the breathing of the subject.

According to some embodiments, the step of controlling of the pressure in the compression vest is facilitated using a control unit.

According to some embodiments, the method may further include fastening or securing the vest to the subject.

According to some embodiments, the subject may be ventilated. In some embodiments, the subject may be breathing spontaneously.

According to some embodiments, the compression therapy is configured to reduce or ameliorate at least one symptom associated with the respiratory condition.

According to some embodiments, the therapy may be applied in intermittent sessions, each session in the length of about 5 minutes to about 5 hours. According to some embodiments, the compression therapy may be applied continuously.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1—A perspective front view of a compression vest, according to some embodiments;

FIG. 2—a schematic front view illustration of columns of inflatable bladders of a compression vest, according to some embodiments;

FIG. 3A—a schematic view of a side cross of a column of bladders, according to some embodiments;

FIG. 3B—a schematic top view of a cross section of a column of bladders of a compression vest, according to some embodiments;

FIG. 4—a block diagram of a controller device, according to some embodiments;

FIG. 5—a schematic illustration of a system for providing compression therapy, according to some embodiments;

FIG. 6—a schematic diagram of a compression system, according to some embodiments; and

FIG. 7—a block diagram of steps in a method of applying compression therapy to chest of a subject.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, each of the words “comprise” “include” and “have”, and forms thereof, are not necessarily limited to members in a list with which the words may be associated.

As used herein, “right” and “left” refer to the right and left directions from the center of body of a subject. In some embodiments, left and right are determined by the sagittal plane (longitudinal, anteroposterior), which is parallel to the sagittal suture. In some embodiments, the terms “left” and “left hand side” may interchangeably be used. In some embodiments, the terms “right” and “right hand side” may interchangeably be used.

As used herein, the terms “top” and “bottom” refer to top and bottom directions of a subject body. In some embodiments, “top” is relatively closer to the head region and “lower” is relatively closer to the leg region. In some embodiments, top and bottom are relative to the transverse plane (axial or horizontal plane), which divides the body into cranial and caudal (head and tail) portions.

As used herein, the terms “bladder”, “inflatable bladder”, “compartment”, “cell”, “pressure cell”, “chamber” and “pocket” may interchangeably be used. The terms relate to a cell capable of being inflated, deflated or maintain fluid therein. In some embodiments, the bladders disclosed herein are linearly arranged in one or more columns, whereby each column includes at least three consecutive bladders, wherein the first (top) and last (bottom) bladder in each triplet of bladders overlap with the middle (center) bladder. A used herein, the term column is directed to a consecutive arrangement of bladders, from top to bottom. In some embodiments, a column may acquire various geometrical shapes and is not necessarily limited to a cylindrical shape.

As used herein, the term “respiratory related condition”, “ventilation related condition” and “breathing related condition” may interchangeably be used. The terms relate to a condition affecting the respiratory system of a subject. In some embodiments, the condition is related to infection, inflammation, tumor, or any other pathological condition affecting the tissues and organs involved in or related to breathing. In some embodiments, such tissues or organs include, for example the respiratory tract, lung, trachea, bronchi, bronchioles, alveoli, pleurae, pleural cavity, nerves of respiration, muscles of respiration, and the like, or any combination thereof. In some embodiments, the respiratory related condition is a disease affecting the airways (such as trachea and bronchi), a disease affecting the air sacs (alveoli, bronchioles), a disease affecting the interstitium (lining between alveoli), a disease affecting pulmonary blood vessels, diseases affecting the pleura (thin lining surrounding the lungs), diseases affecting the chest wall, or any combination thereof. Each possibility is a separate embodiment.

In some embodiments, a respiratory related condition may be selected from, but not limited to: asthma, chronic obstructive pulmonary disease (COPD), chronic bronchitis, emphysema, acute bronchitis, cystic fibrosis (CF), pneumonia, tuberculosis, pulmonary edema, acute respiratory distress syndrome (ARDS), COVID-19 infection, pneumoconiosis, interstitial lung disease (ILD) (including, sarcoidosis, idiopathic pulmonary fibrosis, and autoimmune disease), pulmonary embolism (PE), pulmonary hypertension, pleural effusion, pneumothorax, mesothelioma, obesity hypoventilation syndrome, neuromuscular disorders, lung cancer, and the like, or any combination thereof. Each possibility is a separate embodiment.

As used herein, the term “breathing cycle” relates to the stages in the breathing cycle of a subject (i.e., changes in pressure, lung volume, and airflow that occur during a single cycle of breathing). The stages include rest, inhalation (introducing air into the respiratory system) and exhalation (expiring/ removing air from the respiratory system. During rest there is no net movement of air into or out of the lungs. During inspiration there is a net movement of air into the lungs and the volume of the lungs. During expiration there is a net movement of air out of the expanded lungs.

As used herein, the term “subject” and “patient” may interchangeably be used. The term relates to a subject subjected to compression therapy. In some embodiments, the terms relate to a subject afflicted with a respiratory condition. In some embodiments, the subject is ventilated. In some embodiments, the subject is mechanically ventilated. In some embodiments, the subject is sedated. In some embodiments, the subject is conscious. In some embodiments, the subject is spontaneously breathing (self-breathing). In some embodiments, the subject is spontaneously breathing without ventilatory support (unassisted spontaneous breathing). In some embodiments, the subject is breathing spontaneously with assisted ventilation (assisted spontaneous breathing). In some embodiments, the assisted spontaneous ventilation may be invasive or non-invasive. In some embodiments, the subject being treated with compression therapy is laying down during at least a portion of the treatment session. In some embodiments, a subject being treated with compression therapy is sitting or standing during at least a portion of the treatment session.

In some embodiments, the subject may be connected to, or be associated with a breathing related device, including, for example, a ventilator, BPAP, CPAP, a cough stimulator, and the like, or any combination thereof. Each possibility is a separate embodiment.

As used herein, the term “treating” relates to application of compression therapy to a subject in need thereof. In some embodiments, the compression therapy is a pneumatic compression therapy. In some embodiments, the compression therapy includes a session of therapy, in the length of about 1-60 minutes, whereby continuous or intermittent pressure is applied to the to the subject's body, for example the chest of the subject. In some embodiments, the treatment can at least partially ameliorate one or more symptoms associated with the respiratory condition, including, for example, but not limited to: improvement of breathing quality, increasing (improving) air flow, increasing (improving) oxygen saturation, reducing pain, reducing discomfort, and the like, or any combinations thereof.

As used herein, the term “health care provider”, “user”, “physician” relate to a provider of therapy to a subject in need thereof.

As used herein, the term “about” is used to specify a value of a quantity or parameter (e.g. the length of an element) to within a continuous range of values in the neighborhood of (and including) a given (stated) value. According to some embodiments, “about” specifies the value of a parameter to be between 80% and 120% of the given value. For example, the statement “the length of the element is equal to about 1 m” is equivalent to the statement “the length of the element is between 0.8 m and 1.2 m”. According to some embodiments, “about” specifies the value of a parameter to be between 90% and 110% of the given value. According to some embodiments, “about” specifies the value of a parameter to be between 95% and 105% of the given value.

According to some embodiments, there is provided an advantageous compression device, for example, in the form of a compression vest, having a unique arrangement of compression bladders, having at least partial overlap therebetween, configured to allow compression therapy to a subject's chest, while operating in synchronization with the breathing cycle of the subject (i.e., pressure changes in the compression therapy are in accordance with stages of the breathing cycle).

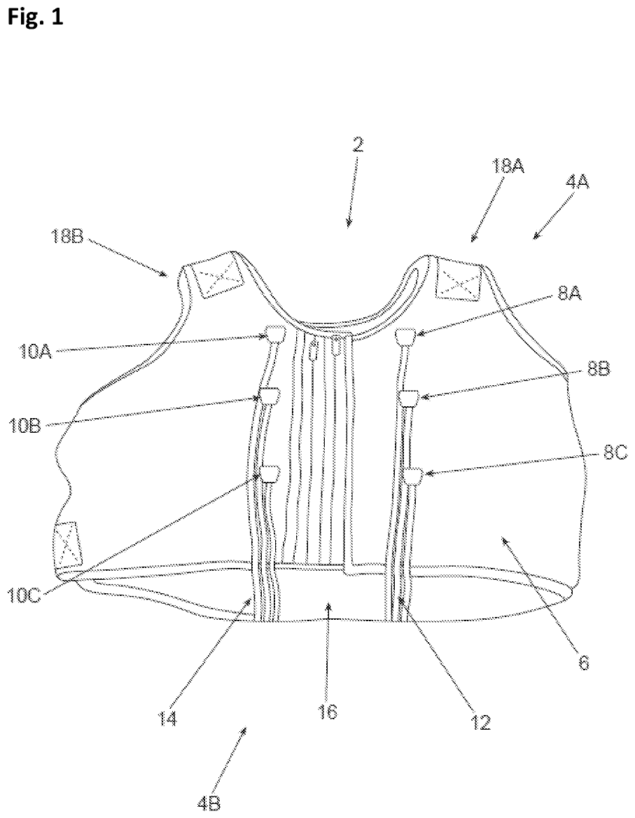

Reference is now made to FIG. 1, which shows a perspective front view of a compression vest, according to some embodiments. As shown in FIG. 1, vest 2 is generally shaped to conform to a body of a subject, in particular, the front side 6 thereof is configured to be placed on the chest of a subject, and the back side thereof (internal portion 16 of the back side is shown) is configured to face or associate with the back of the subject. As shown in FIG. 1, the vest has a top end 4A and a bottom end 4B, corresponding to the body directions. At the top end region of the vest, straps (shown as shoulder straps 18A-B) are located. The straps are configured to be placed over the shoulders of the subject and are configured to assist in positioning and/or securing the vest to the body of the subject. The straps may be made as continuous straps, or may be made of at least two separable portions that may be attached thereto by any suitable means, including, for example, zippers, Velcro, and the like. The external layer of the vest and/or any other portions thereof may be made of any suitable material, including, for example, but not limited to: any type of fabric (woven or non-woven), plastic, nylon, rubber, and the like, or any combination thereof. The vest may be made or constructed or fabricated as one continuous element. In some embodiments, the vest may be made or constructed as one continuous element whereby two opposing ends thereof are configured to attach thereto (associate therewith) by any suitable fastening or securing means, such as, laces, zippers, Velcro, hooks and loops, buttons, flaps, and the like. For examples, the opposing ends of the vest may be separated along a separation line on the front face of the vest, substantially at the middle or center of the vest, whereby the two ends of the vest may be attached or brought together thereto after or before the vest is being placed on the body of the subject. In some embodiments, the opposing ends of the vest may be removably fastened onto one another. By such setting, customizable fitting of the vest to the body of the subject, may be achieved, to thereby accommodate a variety of body sizes and statures (men, women, children, obese, lean, and the like). In some embodiments, the vest at least partially engages the subject body. As further detailed below, the vest includes at least one column of inflatable bladders, linearly arranged, whereby a top bladder and a bottom bladder at least partially overlap with an intervening middle bladder. The columns of bladders are not shown in FIG. 1, as they reside under the external layer of the vest. In some embodiments, in cases where two columns are present, the columns may be substantially parallel thereto. In some embodiments, such two columns may each reside on opposite sides of the separation line of the vest, if present, such that after the opposing ends are attached thereto, the two columns are brought closer to each other. As further detailed below, each of the inflatable bladders may include a ventilation opening configured to allow the insertion, removal or maintaining of fluid (such as, gas in the form of air) in the bladders. The ventilation opening may be connected to suitable fluid hoses/tubes, allowing the insertion or removal of fluid from the bladders and may each be controlled separately, as further detailed below. Shown in FIG. 1 are ventilation holes 8A-8C of three bladders of a first column (not shown) and ventilation holes 10A-10C of three bladders of a second column (not shown). Further shown are fluid hoses 12 and 14.

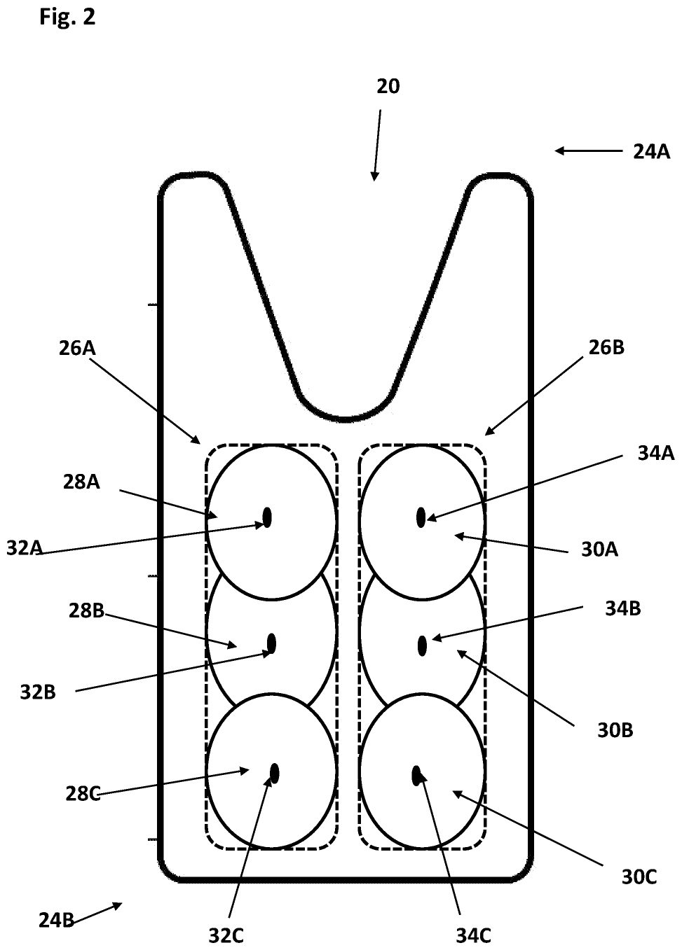

Reference is now made to FIG. 2, which shows a schematic front view illustration of columns of inflatable bladders of a compression vest, according to some embodiments.

As shown in FIG. 2, vest 20 has a top end 24A and a bottom end 24B. The vest is configured to be placed/located/secured to a chest of a subject. On the front side of the vest at least three inflatable bladders arranged in a column are located. Shown in FIG. 2 is a first inflatable bladder column 26A, which is made of separable inflatable bladders, 28A-C, linearly arranged, from top to bottom, such that top (first) bladder 28A at least partially overlap with middle bladder 28B and bottom (last) bladder 28C at least partially overlaps with middle bladder 28B. Further shown is a second inflatable bladder column 26B, which is made of separable inflatable bladders, 30A-C, linearly arranged, from top to bottom, such that top (first) bladder 30A at least partially overlap with middle bladder 30B and bottom (last) bladder 30C at least partially overlaps with middle bladder 30B. The two columns may be substantially parallel thereto. Further shown in FIG. 2 are ventilation openings 32A-C, of bladders 28A-C, respectively, and ventilation openings 34A-C, of bladders 30A-C, respectively. As further detailed below, the pressure in each of the bladders (as determined by the amount or pressure of fluid inserted, removed, or maintained in the bladder) may be separately controlled/determined. The bladders in each column of bladders may be similar, identical or different for any two or more bladders. The bladders may be similar, identical or different therebetween with respect to one or more properties thereof, including, for example, shape, size, form, composition (i.e., material they are made of), physical properties (such as, elasticity), chemical properties, or any combination thereof. Each possibility is a separate embodiment. In some embodiments, at least the top and bottom bladders may be similar or identical with respect of one or more properties (such as, size and shape). In some embodiments, when the vest includes more than one column of inflatable bladders, each of the columns may be identical, similar or different from each other in one or more properties, including, for example, but not limited to: shape, size, number of bladders, distribution of bladders, bladder characteristics, and the like, or any combination thereof. Each possibility is a separate embodiment.

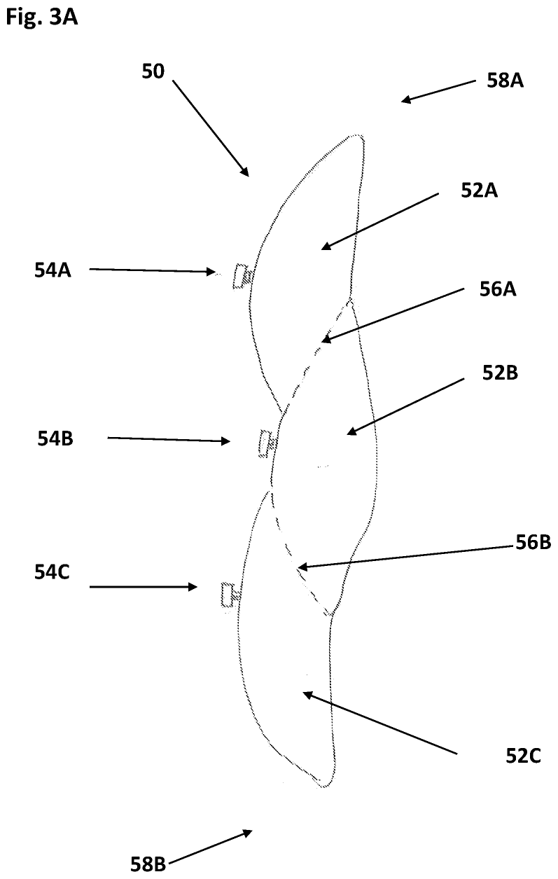

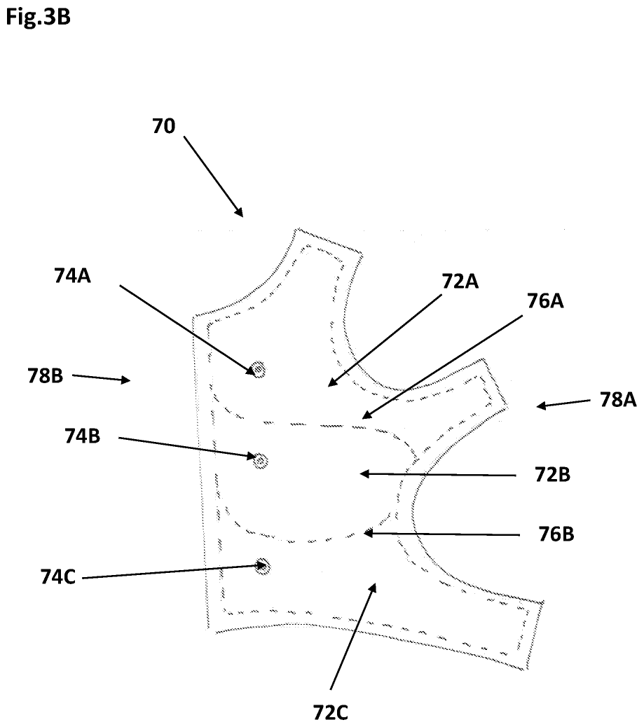

Reference is now made to FIG. 3A, which is a schematic view of a side cross of a column of bladders, according to some embodiments. As shown in FIG. 3A, column 50, is oriented from top end 58A to bottom end 58B, whereby bladders 52A-C are linearly arranged from the top end to the bottom end, and are shown in an inflated (or at least partially inflated) state. As shown in FIG. 3A, top bladder 52A at least partially overlaps with middle bladder 52B, and bottom bladder 52C at least partially overlaps with middle bladder 52B. More particularly, top (first) bladder 52A overlap with middle bladder 52B along at least a portion of their walls, indicated by seem line 56A. Similarly, bottom (last) bladder 52C overlap with middle bladder 52C along at least a portion of their walls, indicated by seem line 56B. By such setting of advantageous overlapping between the bladders (i.e, for each triplet of bladders, the external bladders (i.e., the first and last) at least partially overlap with the intervening middle bladder), and efficient compression therapy is achieved, as further detailed herein. Further shown in FIG. 3A are the ventilation openings 54A-C, allowing a fluid passage to and from each of the bladders 52A-C. The ventilation openings are facing the external side (i.e, the side that is furthest from the subject body), while the opposing side 60 of the bladders faces the subject body (in particular the chest of the subject).

Reference is now made to FIG. 3B, which is a schematic top view of a cross section of a column of bladders of a compression vest, according to some embodiments. As shown in FIG. 3B, column 70, includes three bladders, 72A-C, shown in a deflated state, whereby the bladders are linearly arranged from top end to bottom end. As shown in FIG. 3B, a top bladder 72A at least partially overlap with middle bladder 74B and bottom bladder 72C at least partially overlaps with middle bladder 72B, at least along seem lines 76A-B, respectively. As further shown, each of bladders may extend along a respective width of the column, such that the bladders may extend transversely, from one side edge 78A of the column to the other side edge 78B thereof, to thereby increase the surface area over which the compression therapy may be applied to. Further shown are ventilation openings 74A-C, allowing a fluid passage to and from each of the bladders 52A-C, respectively.

According to some embodiments, the bladders may be constructed of any suitable material. For example, walls of the bladders may be made of such materials as, but not limited to: polyethylene (PE), ethylene-vinyl acetate (EVA), or polyvinyl chloride (PVC), thermoplastic polyurethane (TPU), and the like or combinations thereof. In some embodiments, each of bladders may extend along, or substantially along, a respective length of a column (i.e., the bladders may extend transversely, from one side edge of the column to the other side edge thereof, or substantially transversely).

According to some embodiments, at least a portion of the lower wall region of a top bladder is connected to the at least a portion of the upper wall region of a middle bladder, and at least a portion of the upper wall region of the bottom bladder is connected to at least a portion of the lower wall regions of the middle bladder. The connection may be along seem line. In some embodiments, the respective wall portions may be stitched, glued, adhered and/or welded thereto along the seam lines. In some embodiments, the seams are airtight. The construction or fabrication of overlapping bladders may be performed by methods known in the art, such as, for example, by welding, adhering, gluing, stitching, and the like, of respective portions, walls or layers of the respective bladders.

According to some embodiments, the ventilation openings of the bladders are configured to allow for the pumping/insertion of fluid (such as, air) into the bladder, and the outflow of fluid (for example by passive or active deflation) from, the bladders, thereby inflating and deflating the bladders. According to some embodiments, the ventilation openings may be in the form of a female connector (for example, in the form of a socketed member), or in the form of a male connector (for example, in the form of tubular spouts). Apart from the fluid connectivity provided by the ventilation openings (fluidly connecting the inside of each of the bladders to the outside), the bladders are fluidly sealed (i.e., airtight). In some embodiments, the ventilation openings are aligned thereto. In some embodiments, the ventilation openings may each be connected to a separate fluid tube/hose. In some embodiments, at least some of the ventilation openings may be connected to a common fluid tube/hose.

According to some embodiments, the pressure in each of the bladders may independently be in the range of about 1-150 mmHg. According to some embodiments, the pressure in each of the bladders may independently be in the range of about 10-130 mmHg. According to some embodiments, the pressure in each of the bladders may independently be in the range of about 15-120 mmHg. In some embodiments, each of the bladders may be configured to inflate, deflate or maintain similar or different pressures. In some embodiments, the pressure applied by a column of a vest may be in the range of about 1-150 mmHg, 10-130 mmHg, 15-120 mmHg, or any subranges thereof.

According to some embodiments, the compression vest, or portions thereof may be disposable. According to some embodiments, the compression vest may washable and reusable.

According to some embodiments, the operation/control of operation of the compression vest may be utilized using one or more suitable controllers, allowing the inflation/deflation of the inflatable bladders, in order to provide compression therapy to the subject.

In some embodiments, the control of operation/operation of the compression vest is performed such that the compression therapy is applied in accordance with the breathing cycle of the subject. In some embodiments, the control of operation/operation of the compression vest is performed such that the compression therapy is applied at least partially in synchronization of the breathing cycle of the subject.

In some embodiments, by applying the compression therapy in coordination with the breathing cycle of the subject, the efficiency, efficacy and accuracy of the compression therapy is vastly increased.

According to some embodiments, there is provided a controller device configured to control operation of a compression vest, in coordination with the breathing cycle of the subject.

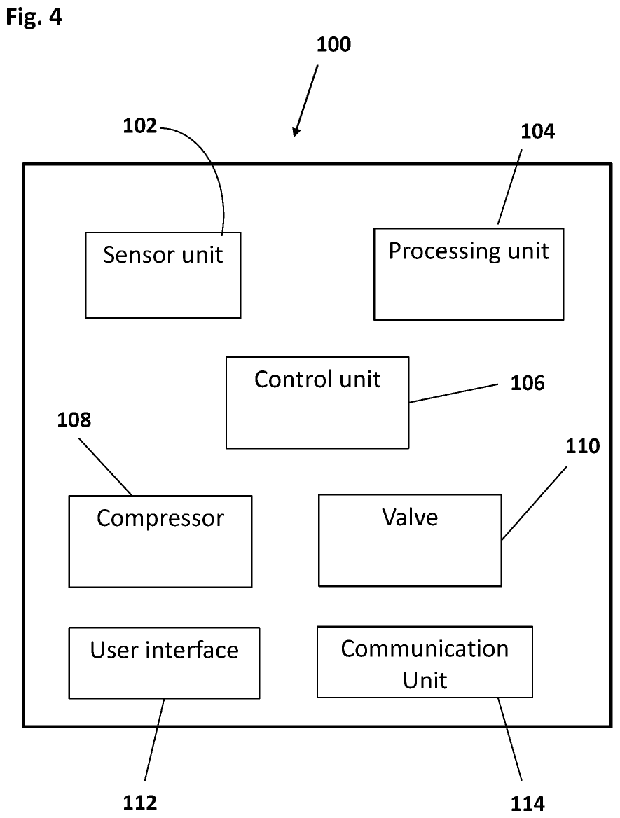

Reference is now made to FIG. 4, which is a block diagram of a controller device, according to some embodiments. As shown in FIG. 4, controller device 100 includes several operative units, configured to, inter alia, sense, detect, identify breath cycle parameters or breath cycle related parameters, determine a suitable compression therapy and accordingly control operation of the compression. Device 100 includes a sensor unit 102. The sensor unit is configured to sense/detect, directly or indirectly one or more parameters related to the breathing of the subject. In some embodiments, the sensor unit includes or is associated with one or more suitable sensors capable of or configured to sense breath related parameters. In some embodiments, the sensor unit may include or be associated with a pressure sensor, a flow sensor, a motion (movement) sensor, strain sensor, or combinations thereof. In some embodiments, the pressure sensor and/or the flow sensor may be located on or along the exhaled and/or inhaled air path of the subject. For example, the pressure sensor or flow sensor may be located on or along a ventilation tube or ventilation mask used by the subject. In some embodiments, the pressure sensor or flow sensor may be located in the controller device and may directly or indirectly connected to breathing tube, ventilation tube, ventilation mask used by the subject. According to some embodiments, a motion sensor may be located on the chest of the subject, and is configured to sense chest movement (for example, up-down movement) during breathing cycle of the subject and convey information obtained to the sensing unit. Such motion sensor can be implemented using strain gauge of any kind, including conductive rubber transferring mechanical strain to electric resistance value. According to some embodiments, the sensor unit is configured to identify or detect pressure values in the range of about −35 to about +45 mmHg, for example, in the range of about −20 (minus 20) to about +30 mmHg. In some embodiments, negative pressure may be achieved when a breathing related device is being used (connected/associated) with the patient. As further shown in FIG. 4, controller device 100 includes a processing unit 104. Processing unit 104 is configured to process data obtained from the sensor unit to at least partially determine stages of the breathing cycle of the subject and/or determine air pressure values during the breathing cycle. The processing unit include one or more processors, control boards, memory modules, and the like, or combinations thereof. Controller device 100 further includes a control unit 106. Control unit 106 is configured to control pressure in the compression vest, based on data processed by the processing unit, wherein the pressure in the compression vest is determined in accordance with the determined breathing cycle stages and/or the air pressure values during the breathing cycle. The control unit is configured to control the operation of one or more fluid compressors (shown as compressor 108), configured to provide fluid, such as, air, to the inflatable bladders. The compressor is configured to inflate or deflate the compression vest, based on instructions from the control unit, whereby the amount of inflation/deflation or pressure determination may be at least partially controlled by in-line pressure sensor (or in-line pressure sensor unit) configured to sense/determine/control the pressure in the inflatable bladders. The compressor may be of any suitable type and is configured to provide any suitable amount/pressure of fluids to the inflatable bladders. As shown in FIG. 4, the controller device may further include one or more valves, shown as valves 110, configured to control pressure in the bladders of the compression vest. The valves may be of any type, and in some exemplary embodiments, the valves may be electrical solenoid valves. In some embodiments, each bladder may be associated with or connected to a sperate valve. In some embodiments, one or more bladders may be associated with or connected to a common valve. In some embodiments, the operation of the valves (opening/close) may be determined based on data/information received from the in-line pressure sensor. In some embodiments, the operation of the valves may be controlled by the control unit 106. Controller device 100 may further optionally include a user interface unit (UI) 112. User interface unit 112 may include one or more of: keyboard, display, tracking device, touch screen, or any combination thereof, allowing a user (such as a health care provider) to interact with the controller device. Interacting with the controller device may include, for example, determining operating parameters, reviewing operating parameters, monitoring operation, and the like. Controller device 100 may further optionally include a communication unit. In some embodiments, the communication unit may include wired and/or wireless communication modalities. In some embodiments, the communication unit may include Bluetooth communication modality, Wi-Fi communication modality, Near field communication modality (NFC), USB, HDMI, ethernet, or combinations thereof. The communication unit may be used to convey information to and from the controller device, for example, by communicating operating parameters, sensed parameters, breath related data, details of compression therapy, and the like, to an external or remote location.

According to some embodiments, the controller unit (in particular, the processing unit thereof) may be configured to store data obtained from the sensor unit (for example. in a memory module) and to further process said data to determine a personalized and/or optimized compression cycle. In some embodiments, the determination of a personalized and/or optimized compression cycle may include the use of machine learning algorithms, which may take into account, inter alia, breath related parameters of the patient from one or more previous breath cycles. In some embodiments, additionally or alternatively, breath related parameters may be obtained from one or more databases (such as, for example, server or cloud based databases). In some embodiments, a reliability score related to the quality of the compression cycle (for example, the accuracy or customization of the breath cycle) may be calculated. In some embodiments, the reliability score may be calculated for each compression cycle, for a number of compression cycle (consecutive or intermittent), or for the entire therapy session. In some embodiments, the reliability score may be used produced by the machine learning algorithms and may further be used by the machine learning algorithm(s) to increase the reliability (i.e., accuracy and customization) of the compression cycles.

According to some embodiments, the controller device is configured to inflate, deflate or maintain pressure in the compression vest (in particular in bladders of the compression vest), based on the determined breathing cycle stages and/or the air pressure values during the breathing cycle of the subject.

According to some embodiments, the controller device is configured to operate continuously over an extended or uninterrupted period of time, or intermittently, over sessions of various length (for example, 5 minutes to 2 hours).

According to some embodiments, the controller device may further include a power supply unit. According to some embodiments, the controller device may be comprised in a suitable housing. In some embodiments, the controller device may be in the form of a console, which may be stationary or portable.

According to some embodiments, there is provided a system for providing compression therapy to a subject, in synchronization with the breathing cycle of the subject, including the compression vest as disclosed herein and the controller device as disclosed herein.

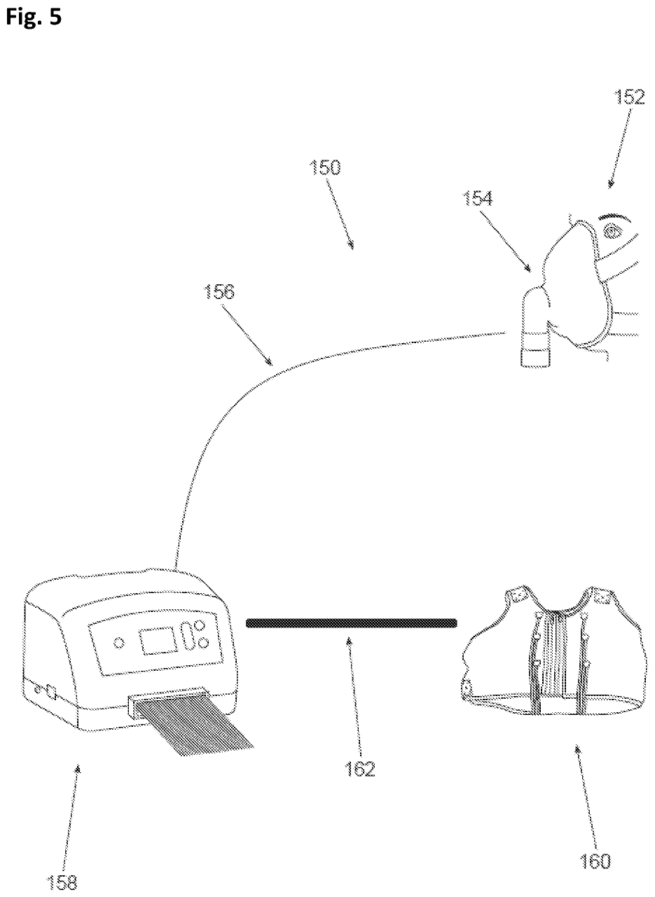

Reference is now made to FIG. 5, which is a schematic illustration of a system for providing compression therapy, according to some embodiments. As shown in FIG. 5, system 150 includes a controller device 158, which is configured to control operation of compression vest 160. The controller device is configured to sense/obtain information related to breathing of a subject 152, at least partially determine stages of the breathing cycle of the subject and/or air pressure values during the breathing cycle and accordingly determine the required operation of the compression vest, by inflating, deflating or maintaining pressure in bladders of the compression vest (for example, via air tube 162 configured to provide air (for example, from an air compressor) from the controller device to the respective bladders. The information related to the breathing of subject 152 may be obtained from example, from sensors of the controller unit, associated with air tube 156 connected to ventilation mask 154 used by the subject. Thus, by using a system such as system 156, enhanced compression therapy is provided to the subject, whereby the operation of the advantageous compression vest capable of at least partially mimicking manual massage of the chest, is at least partially synchronized with the breathing pattern or breathing cycle of the subject, to increase efficiency and accuracy of treatment.

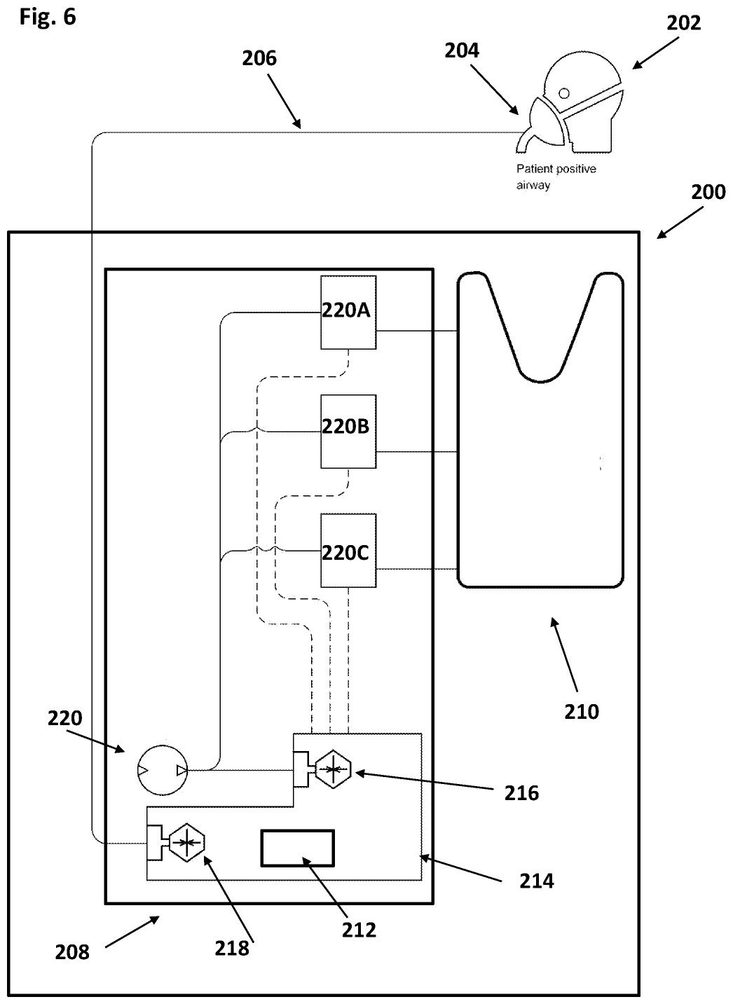

Reference is now made to FIG. 6, which is a schematic diagram of a compression system, according to some embodiments. As shown in FIG. 6, system 200 includes a controller device 208, which is configured to control operation of compression vest 210, which is configured to apply compression therapy to subject 202. Breathing related parameters of subject 202 are being sensed/detected (directly or indirectly) by sensing unit 218 of controller device 208. For example, the breathing related parameters may be obtained by a sensor of sensor unit 208 connected to or associated with breathing tube 206, which is connected to ventilation mask 204 utilized by subject 202. Thus, breathing related parameters detected/sensed by sensor unit 208 are capable of being processed by processing unit 212, which may be an integral part of control unit 214. Based on the information received from processing unit 212, control unit 214 may control operation of the compression vest, by controlling operating of compressor 220, which is configured to provide fluid (such as air) to bladders of the compression vest. The transfer of fluid to and from the bladder is under the control of valves (shown as exemplary valves 220A-C), wherein each bladder may be connected/associated with a separate valve, or at least two bladders may be connected/associated with a common valve. The operation of the valves (for example, close/opening) may be controlled by in-line pressure sensor unit 216. As detailed herein, providing a compression therapy utilizing a system, such as system 200 is highly advantageous, as it increases the treatment accuracy, efficiency and efficacy.

According to some embodiments, the compression therapy system may be utilized continuously or intermittently over any desired period of time beneficial for the subject. In some embodiments, the system is customizable, as it can be adjusted to various types of subjects (such as with respect of age, gender, medical condition, medical history, body stature, weight, height, and the like).

According to some embodiments, the systems and devices disclosed herein may be used in method of applying compression therapy to a subject in need thereof.

In some embodiments, the treatment may be provided continuously or intermittently. In some embodiments, the treatment may be provided is sessions. In some embodiments, the treatment session may be repeated at least once, 2, 4, 6 or more times a day, at any desired time interval therebetween. In some embodiments, each two consecutive treatment sessions may be identical, similar or different therefrom. In some embodiments, the length of a treatment session may be in the range of about 2 minutes to about 6 hours. In some embodiments, the length of a treatment session may be in the range of about 5 minutes to about 1 hour. In some embodiments, the length of a treatment session may be in the range of about 10 minutes to about 2 hours. In some embodiments, the length of a treatment session may be in the range of about 10 minutes to about 30 minutes. In some embodiments, the length of a treatment session may be in the range of about 30 minutes to about 90 minutes. In some embodiments, the length of a treatment session may be at least 10 consecutive breath cycles. In some embodiments, the length of a treatment session may be at least 20 consecutive breath cycles. In some embodiments, the length of a treatment session may be at least 30 consecutive breath cycles.

According to some embodiments, the compression cycles/sessions may be sequential, peristaltic and/or intermittent.

According to some embodiments, there is provided a method for providing or applying a compression therapy to a subject afflicted with a respiratory condition, the method includes one or more of the steps of: placing a compression vest as disclosed herein on the subject, wherein at least one column of bladders is placed on (or in close proximity to) the chest of the subject; sensing one or more parameters related to breathing of the subject; and controlling the pressure in the compression vest in accordance with stages of the breathing cycle of the subject and/or air pressure values during the breathing cycle, wherein the stages and/or air pressure values are determined based on the one or more sensed parameters.

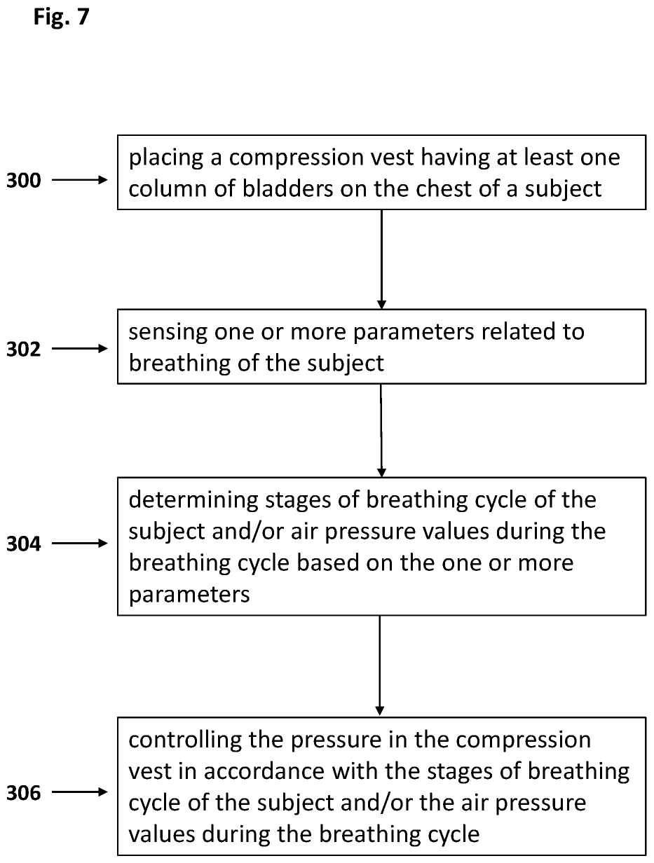

Reference is made to FIG. 7, which is a block diagram of steps in a method of applying compression therapy to chest of a subject. As shown in FIG. 7, step 300 includes placing a compression vest having at least one column of bladders on the chest of a subject. Next, step 302 includes sensing one or more parameters related to breathing of the subject. At step 304, the method includes determining stages of breathing cycle of the subject and/or air pressure values during the breathing cycle based on the one or more parameters. Next step 306 includes controlling the pressure in the compression vest in accordance with the stages of breathing cycle of the subject and/or the air pressure values during the breathing cycle, to thereby provide compression therapy. According to some embodiments, the steps of the method may be repeated continuously or intermittently for any number of times, for any number of breath cycles, for any desired period of time.

In some embodiments, the step of sensing and/or the step of controlling the pressure in the compression vest may be performed continuously or intermittently.

In some embodiments, the pressure values of the one or more bladders are determined for each breath cycle and/or for each step of the breathing cycle.

In some embodiments, the pressure in the bladders may change or be maintained in accordance with the breathing cycle, concomitantly in all bladders, or differentially in one or more bladders.

In some embodiments, the pressure in one or more bladders may be reduced (deflate) during inhalation stage. In some embodiments, the pressure in one or more bladders may be increased (inflate) during inhalation stage. In some embodiments, the pressure in one or more bladders may be reduced (deflate) during exhalation stage. In some embodiments, the pressure in one or more bladders may be increased (inflate) during exhalation stage. In some embodiments, the pressure in one or more bladders may be maintained during inhalation stage. In some embodiments, the pressure in one or more bladders may be maintained during exhalation stage.

According to some embodiments, controlling the pressure in the compression vest may include reducing, maintaining, or increasing the pressure in one or more bladders of the compression vest. In some embodiments, the pressure in each bladder may be similar. In some embodiments, the pressure may change individually in each bladder. In some embodiments, the pressure may change concomitantly in all bladders, or at least in some of the bladders.

According to some embodiments, the method may further include placing or associating one or more sensors on or along the exhaled and/or inhaled airway pathway of the subject and/or on the subject body, wherein the sensors are configured to sense the one or more parameters related to the breathing of the subject. In some embodiments, the sensors may be pressure sensor, flow sensor and/or motion sensor.

According to some embodiments, the step of controlling the pressure in the compression vest, or more particularly in bladders of the compression vest is facilitated using a control unit.

According to some embodiments, the method of treatment may further include a step of fastening, securing and/or adjusting the vest to the subject body, in particular, to the chest of the subject. In some embodiments, placement or adjustment of the vest to the chest of the subject includes aligning one or more columns of bladders over a desired/preferred location on the chest of the subject.

According to some embodiments, the subject may be ventilated. In some embodiments, the subject may be breathing spontaneously.

According to some embodiments, the compression therapy is configured to reduce or ameliorate at least one symptom associated with a respiratory condition.

According to some embodiments, the compression therapy may be applied in addition to an additional treatment of the respiratory condition. In some embodiments, the compression therapy may act in synergy with the additional treatment.

According to some embodiments, the controller unit includes a processing unit or module. According to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices. Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus. The processes and displays presented are not inherently related to any particular computer or other apparatus. Various general-purpose systems may be used with programs in accordance with the teachings herein, or it may prove convenient to construct a more specialized apparatus to perform the desired method(s). In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Or processing unit. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

### EXAMPLES

### Example 1

### Application of Compression Therapy in Coordination with Breathing Cycle of a Subject

The system for compression therapy is utilized to provide compression therapy to a subject in need thereof, in coordination with the detected breathing cycle of the subject.

A compression vest including two columns of inflatable bladders is placed on the chest of the subject, and the breathing of the subject is sensed to determine the breathing cycle stages. The compression cycle of the compression vest is determined and controlled based on the breathing cycle.

Tables 1-3 below detail the steps of three exemplary compression therapy cycles.

Table 1 provides details of a simple compression cycle, whereby all bladders of a column operate synchronously to inflate, deflate or maintain pressure in accordance with inhalation or exhalation stages of the breathing cycle.

Tables 2 and 3 provide detailed of compression therapy cycles, whereby bladders of a column operate individually to inflate, deflate or maintain pressure.

TABLE 1

| Time | Patient Breathing | |
|---|---|---|
| frame | cycle | compression cycle |
| 1 | Inhalation | Deflate (releasing pressure) |
| 2 | Exhalation | Inflate (increasing pressure on |
| | | patients' body) |
| 3 | Inhalation | Hold air (maintaining pressure on |
| | | patients' body) |
| 4 | Exhalation | Deflate (releasing pressure) |

TABLE 2

| Time | Patient Breathing | |
|---|---|---|
| frame | cycle | Compression cycle |
| 1 | Inhalation | Deflate (releasing pressure) |
| 2 | Exhalation | Inflate bladder #1 (increasing |
| | | pressure on patients' body) |
| 3 | Inhalation | Hold air in bladder #1(maintaining |
| | | pressure on patients' body) |
| 4 | Exhalation | Inflate bladder #2 (increasing |
| | | pressure on patients' body) |
| 5 | Inhalation | Hold air in bladders #1 and #2 |
| 6 | Exhalation | Inflate bladder #3 |
| 7 | Inhalation | Hold air in bladders #1, #2 and #3 |
| 8 | Exhalation | Deflate (release air) from bladder #3 |
| | | Hold air in bladders #1 and #2 |
| 9 | Inhalation | Hold air in bladders #1 and #2 |
| 10 | Exhalation | Inflate bladder #3 |
| 11 | Inhalation | Hold air in bladders #1, #2 and #3 |
| 12 | Exhalation | Deflate all 3 bladders (releasing |
| | | pressure) |

TABLE 3

| Time | Patient Breathing | |
|---|---|---|
| frame | cycle | Compression cycle |
| 1 | Exhalation | Deflate (releasing pressure) |
| 2 | Inhalation | Inflate bladders #1, #2 and #3 |
| | | (increasing pressure on patients' |
| | | body) |
| 3 | Exhalation | Hold air in bladders #1, #2 and #3 |
| 4 | Inhalation | Deflate air from bladders #2 and #3 |
| | | (hold air in bladder #1) |
| 5 | Exhalation | Hold air in bladder #1 |
| 6 | Inhalation | Inflate bladders #2, #3 |
| 7 | Exhalation | Hold air in bladders #1, #2, #3 |
| 8 | Inhalation | Deflate (release air) from all |
| | | bladders |

What is claimed is:

1. An inflatable compression vest for providing compression therapy to chest of a subject, the compression vest comprising at least one column of inflatable bladders, said column comprising at least three inflatable bladders consecutively arranged in the column, wherein for each three consecutive bladders, a top and a bottom bladder at least partially overlap with an intervening middle bladder.

2. The inflatable compression vest according to claim 1, comprising at least two columns, each column comprising at least three consecutive inflatable bladders, wherein for each three consecutive bladders, a top and a bottom bladder at least partially overlap with an intervening middle bladder.

3. The inflatable compression vest according to claim 2, wherein the two columns are substantially parallel thereto.

4. The inflatable compression vest according to claim 1, wherein the bladders are configured to inflate, deflate or maintain pressure therein, individually, concomitantly and/or sequentially.

5. The inflatable compression vest according to claim 1, wherein each of the bladders comprise a ventilation opening configured to allow inflating and/or deflating the bladder.

6. The inflatable compression vest according to claim 5, wherein the inflation of the bladder is performed by compressing fluid into the bladder via the ventilation opening.

7. The inflatable compression vest according to claim 1, wherein one or more of the bladders is configured to change or maintain pressure in accordance with stages of breathing cycle of the subject.

8. The inflatable compression vest according to claim 1, wherein the bladders in each column are identical, similar, or different with respect of size, shape and/or composition.

9. The inflatable compression vest according to claim 2, wherein the two columns are identical, similar or different with respect of shape, size, number of bladders, distribution of bladders and/or bladder characteristics.

10. The inflatable compression vest according to claim 1, further comprising one or more fastening elements configured to fasten removably detachable portions of the vest thereto, and/or to fasten the vest to the subject's body.

11. The inflatable compression vest according to claim 1, wherein the pressure within the bladders is in the range of about 15-120 mmHg.

12. A controller device for controlling operation of a compression vest in accordance with breathing cycle of a subject, the device comprising:
a sensor unit configured to detect one or more parameters related to breathing of the subject;
a processing unit configured to process data obtained from the sensor unit to at least partially determine stages of the breathing cycle of the subject and/or air pressure values during the breathing cycle; and
a control unit configured to control pressure in the compression vest, based on data processed by the processing unit, wherein the pressure in the compression vest is determined in accordance with the determined breathing cycle stages and/or the air pressure values during the breathing cycle.

13. The controller device according to claim 14, wherein the sensor unit comprises: a pressure sensor, a flow sensor, a motion sensor, strain gauge or combinations thereof.

14. The controller device according to claim 14, comprising a fluid compressor configured to inflate or deflate the compression vest, based on instructions from the control unit; one or more valves, configured to control pressure in bladders of the compression vest; a user interface and/or a communication unit.

15. The controller device according to claim 12, configured to inflate, deflate or maintain pressure in the compression vest, based on the determined breathing cycle stages and/or the air pressure values during the breathing cycle of the subject.

16. A system for providing compression therapy to a subject, in synchronization with the breathing cycle of the subject, the system comprising:
the compression vest according to any claim 1; and
a controller device according to claim 12, for controlling the operation of the compression vest

17. A method for providing a compression therapy to a subject in need thereof, the method comprising:
placing a compression vest according to claim 1, on the subject, wherein the at least column of bladders is placed on the chest of the subject;
sensing one or more parameters related to breathing of the subject; and
controlling the pressure in the compression vest in accordance with stages of breathing cycle of the subject and/or air pressure values during the breathing cycle, said stages and/or air pressure values are determined based on the one or more sensed parameters.

18. The method according to claim 17, wherein the step of sensing and the step of controlling the pressure are performed continuously.

19. The method according to claim 17, wherein controlling the pressure in the compression vest comprises reducing, maintaining, or increasing the pressure in one or more bladders of the compression vest.

20. The method according claim 17, further comprising placing one or more sensors on or along the exhaled and/or inhaled airway pathway of the subject and/or on the subject body, wherein the sensors are configured to sense the one or more parameters related to the breathing of the subject.

21. The method according to claim 17, wherein controlling of the pressure in the compression vest is facilitated using a control unit.

22. The method according to claim 17, wherein the subject is afflicted with a respiratory related condition, and/or
wherein the subject is breathing spontaneously or is ventilated.

23. The method according to claim 22, wherein the respiratory related condition is selected from: asthma, chronic obstructive pulmonary disease (COPD), chronic bronchitis, emphysema, acute bronchitis, cystic fibrosis (CF), pneumonia, tuberculosis, pulmonary edema, acute respiratory distress syndrome (ARDS), COVID-19 infection, pneumoconiosis, interstitial lung disease (ILD), pulmonary embolism (PE), pulmonary hypertension, pleural effusion, pneumothorax, mesothelioma and obesity hypoventilation syndrome.

24. The method according to claim 22, wherein the compression therapy is configured to reduce or ameliorate at least one symptom associated with the respiratory condition.

25. The method according to claim 17, wherein the compression therapy is applied in intermittent sessions, each session in the length of about 5 minutes-3 hours.
